(19) United States
(12) Patent Application Publication
(10) Pub. No.: US 2026/0253775 A1
(43) Pub. Date: Aug. 27, 2026

(54) ACTUATOR CONTROLLER WITH CONTROL SIGNAL LOSS PROTECTION

(71) Applicant: HONEYWELL INTERNATIONAL INC., Charlotte, NC (US)

(72) Inventors: Shaohui WU, Charlotte, NC (US); Junjie ZHANG, Charlotte, NC (US); Rui TIAN, Charlotte, NC (US); YuZhou XU, Charlotte, NC (US); Zhi Xiong WANG, Charlotte, NC (US)

(21) Appl. No.: 19/160,345

(22) PCT Filed: Mar. 2, 2023
(86) PCT No.: PCT/CN2023/079190

§ 371 Date: Aug. 27, 2025

(51) Int. Cl. H01F 7/06

(52) U.S. Cl. CPC H01F 7/064

(57) ABSTRACT

An actuator controller includes an input port for receiving an input signal and an output port for providing an actuator control signal. A circuit is operatively coupled to the input port and the output port and applies a pull-down bias to the input port such that the input signal is biased toward a zero-value and must be driven by an external controller to overcome the pull-down bias to achieve a non-zero value. In response to detecting the zero-value at the input port, the circuit is configured to apply a pull-up bias and to set the actuator control signal at the output port to correspond to a zero actuator position when the input signal is below a threshold value, and to set the actuator control signal on the output port to correspond to a non-zero actuator position when the input signal rises above the threshold value.

### TECHNICAL FIELD

The present disclosure pertains generally to actuator controllers and more particularly to actuator controllers that are configured to include control signal loss protection.

### BACKGROUND

Building systems such as but not limited to a Heating, Ventilating and Air Conditioning (HVAC) system employ a number of actuators to open and close dampers, to open and close water valves and to control the operation of other HVAC system components. In many cases, a remote building controller may provide commands to each of the actuators. An actuator may receive a command to move to a fully open position, a fully closed position, or any of variety of different intermediate positions. In some cases, the remote building controller may be spaced a considerable distance from some of the actuators. In some cases, communication between the remote building controller and one or more of the particular actuators may be lost due to, for example, a broken or disconnected wire, noise, or some other reason. In such a case, the actuator may not be able to distinguish between when a control signal is actively driven by the remote building controller and when the control signal is simply a remnant of lost communication with the remote building controller. Not recognizing that the control signal is simply a remnant of lost communication with the remote building controller may cause an actuator controller of the actuator to drive the actuator to an improper or even dangerous position. A need remains for an actuator controller that is able to distinguish between when a control signal is actively driven by a remote building controller and when the control signal is simply a remnant of lost communication with the remote building controller.

### SUMMARY

This disclosure relates generally to actuator controllers and more particularly to actuator controllers that are configured to include control signal loss protection. The control signal loss protection may be configured to distinguish between when a control signal is actively driven by a remote controller and when the control signal is simply a remnant of lost communication with the remote controller.

An example may be found in an actuator controller for controlling an actuator. The actuator may be a building control actuator, but this is not required. In some cases, the actuator may be an industrial process actuator for controlling at least part of an industrial process such as a manufacturing process. In some cases, the actuator may be an aviation actuator for controlling one or more functions of an aircraft or spacecraft. These are just examples.

The actuator controller includes an input port for receiving an input signal from an external or remote controller and an output port for providing an actuator control signal to an actuator position controller of the actuator. A circuit is operatively coupled to the input port and the output port. The circuit is configured to apply a pull-down bias to the input port such that the input signal on the input port is biased toward a zero-value and must be driven by the external controller to overcome the pull-down bias to achieve a non-zero value. In response to detecting the zero-value at the input port, the circuit is configured to apply a pull-up bias to the input port and monitor the resulting input signal at the input port. The circuit is configured to set the actuator control signal at the output port to correspond to a zero actuator position when the resulting input signal at the input port is below a threshold value and set the actuator control signal on the output port to correspond to a non-zero actuator position when the resulting input signal at the input port rises above the threshold value.

Another example may be found in a method for controlling an actuator that receives an input signal at an input port from an external controller. The illustrative method includes applying a pull-down bias to the input port such that an input signal on the input port is biased toward a zero-value and must be driven by the external controller to overcome the pull-down bias to achieve a non-zero value. In response to detecting the zero-value at the input port, the method includes applying a pull-up bias to the input port, and while applying the pull-up bias to the input port, determining whether the input signal is below a threshold value or above the threshold value. When it is determined that the input signal is below the threshold value, an actuator control signal is set to correspond to a zero actuator position. When it is determined that the input signal is above the threshold value, the actuator control signal is set to correspond to a non-zero actuator position (e.g. a predetermined target position or the existing position). The method includes controlling the actuator based on the actuator control signal.

Another example may be found in an actuator controller for controlling an actuator. The actuator controller includes an input port for receiving an input signal from an external controller and an output port for providing an actuator control signal to an actuator position controller of the actuator. A circuit is operatively coupled to the input port and the output port. The circuit is configured to apply a first bias to the input port such that the input signal on the input port is biased toward a first-value and must be driven by the external controller to overcome the first bias to achieve a second value. In response to detecting the first-value at the input port, the circuit is configured to apply a second bias different from the first bias to the input port. The circuit is configured to set the actuator control signal at the output port to a first actuator position when the input signal at the input port does not deviate from a threshold value by a threshold amount, and set the actuator control signal on the output port to a second actuator position when the input signal at the input port deviates from the threshold value by at least the threshold amount.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments of the disclosure in connection with the accompanying drawings, in which:

FIG. 1 is a schematic block diagram showing an illustrative actuator controller;

FIG. 2 is a flow diagram showing an illustrative method for controlling an actuator;

FIG. 3 is a flow diagram showing an illustrative method for controlling an actuator;

FIG. 4 is a flow diagram showing an illustrative method for controlling an actuator;

FIG. 5 is a schematic diagram showing an illustrative circuit;

FIG. 6 is a flow diagram showing an illustrative method;

FIG. 7 is a schematic diagram showing an illustrative circuit;

FIG. 8 is a flow diagram showing an illustrative method; and

FIG. 9 is a flow diagram showing an illustrative method.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements. The drawings, which are not necessarily to scale, are not intended to limit the scope of the disclosure. In some of the figures, elements not believed necessary to an understanding of relationships among illustrated components may have been omitted for clarity.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

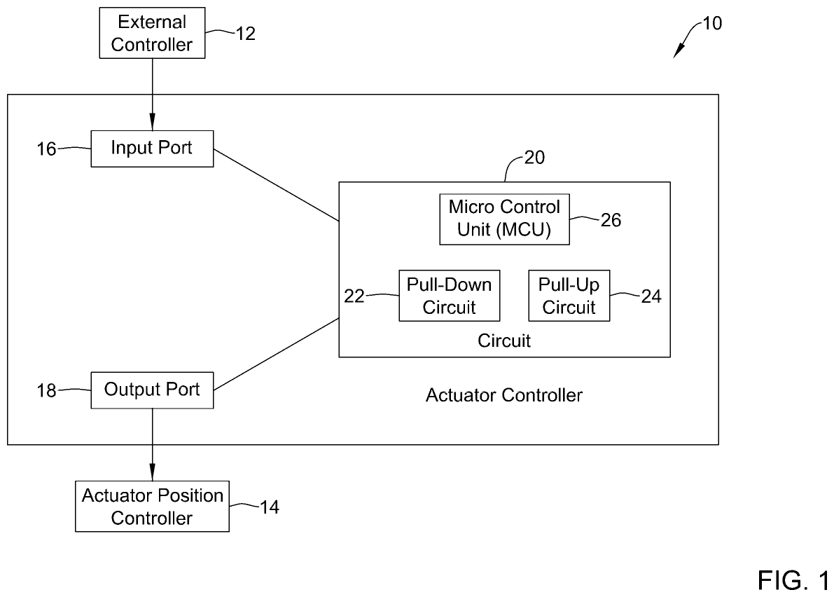

FIG. 1 is a schematic block diagram of an illustrative actuator controller 10. The actuator controller 10 may be part of an actuator. The actuator may be a building control actuator, but this is not required. In some cases, the actuator may be an industrial process actuator for controlling at least part of an industrial process such as a manufacturing process. In some cases, the actuator may be an aviation actuator for controlling one or more functions of an aircraft or spacecraft. These are just examples.

The illustrative actuator controller 10 may communicate with an external controller 12 and with an actuator position controller 14 of the actuator. In some instances, the external controller 12 may be a building controller that oversees operation of a plurality of actuators within a building system. The actuator position controller 14 may be configured to control the actual position of a particular actuator, for example. In some instances, the actuator position controller 14 may be configured to also receive position feedback information from the actuator. While shown as a separate component, in some instances the actuator position controller 14 may be included as part of the actuator.

The illustrative actuator controller 10 includes an input port 16 that may be configured to receive an input signal from the external controller 12 as well as an output port 18 that may be configured to provide an actuator control signal to the actuator position controller 14. A circuit 20 is operatively coupled to the input port 16 and the output port 18. In some instances, the circuit 20 may be configured to apply a first bias to the input port 16 such that the input signal on the input port 16 is biased toward a first-value and must be driven by the external controller to overcome the first bias to achieve a second value. In response to detecting the first-value at the input port 16, the circuit 20 may be configured to apply a second bias different from the first bias to the input port 16. With the second bias applied, the circuit 20 determines whether the input signal at the input port 16 does or does not deviate from a threshold value by at least a threshold amount. The circuit 20 is configured to set the actuator control signal at the output port 18 to a first actuator position when the circuit 20 determines that the input signal at the input port 16 does not deviate from the threshold value by the threshold amount, and to set the actuator control signal on the output port 18 to a second actuator position when the circuit 20 determines that the input signal at the input port 16 does deviate from the threshold value by at least the threshold amount. In some cases, the first bias may be a pull-down bias and the second bias may be a pull-up bias. In some cases, the first bias may be a pull-up bias and the second bias may be a pull-down bias.

In some instances, the circuit 20 is configured to apply a pull-down bias to the input port 16 such that the input signal on the input port 16 is biased toward a zero-value and must be driven by the external controller 12 to overcome the pull-down bias to achieve a non-zero value. In response to detecting the zero-value at the input port 16, the circuit 20 is configured to apply a pull-up bias to the input port 16. The circuit 20 is configured to set the actuator control signal at the output port 18 to correspond to a zero actuator position when the input signal at the input port 16 remains below a threshold value and to set the actuator control signal on the output port 18 to correspond to a non-zero actuator position when the input signal at the input port 16 rises above the threshold value. In some instances, the non-zero actuator position may correspond to, for example, a non-zero target position of the actuator, an existing position of the actuator, or another position. In some instances, the zero-value may correspond to a voltage that is below a zero-value threshold, and the non-zero value may correspond to a voltage above the zero-value threshold. The zero-value threshold may be, for example, 1 volt, 0.5 volts, 0.2 volts, 0.1 volts or any other threshold. In some cases, the threshold value may correspond to the zero-value threshold.

In some instances, the circuit 20 may include a pull-down circuit 22 that applies the pull-down bias to the input port 16, wherein the pull-down circuit 22 includes a pull-down resistance positioned electrically between the input port 16 and ground. In some cases, the pull-down circuit 22 may include a pull-down switch that selectively electrically interconnects the pull-down resistance between the input port 16 and ground. In some instances, the circuit 20 may include a pull-up circuit 24 that applies the pull-up bias to the input port 16. In some cases, the pull-up circuit 24 includes a pull-up resistance positioned electrically between the input port 16 and a pull-up voltage. In some cases, the pull-up circuit 24 may include a pull-up switch that selectively electrically interconnects the pull-up resistance between the input port and the pull-up voltage.

In some instances, the circuit 20 may include a micro control unit (MCU) 26 that controls the pull-down switch and the pull-up switch when the pull-down switch and/or the pull-up switch are provided. The MCU 26 may be configured to detect the zero-value at the input port 16 and in response to detecting the zero-value at the input port, the MCU 26 may be configured to close the pull-up switch to selectively electrically interconnect the pull-up resistance between the input port 16 and the pull-up voltage. After closing the pull-up switch, the MCU 26 may determine whether the input signal at the input port 16 is below the threshold value or above the threshold value. When it is determined that the input signal remains below the threshold value, it is assumed that the input signal is being driven by the external controller 12 to the zero position, and the MCU 26 sets the actuator control signal at the output port 18 to correspond to the zero actuator position. When it is determined that the input signal rises above the threshold value, it is assumed that the input signal is not being actively being driven by the external controller (e.g. lost input signal), and the MCU 26 sets the actuator control signal at the output port 18 to correspond to a non-zero actuator position, such as a predetermined target position or the existing position of the actuator.

In a particular example, the pull-down circuit 22 applies the pull-down bias to the input port 16 and includes a pull-down resistance that is positioned electrically between the input port and ground and a pull-down switch that selectively electrically interconnects the pull-down resistance between the input port and ground. The MCU 26 may be configured to open the pull-up switch and close the pull-down switch when applying the pull-down bias and to open the pull-down switch and close the pull-up switch in response to detecting the zero-value at the input port.

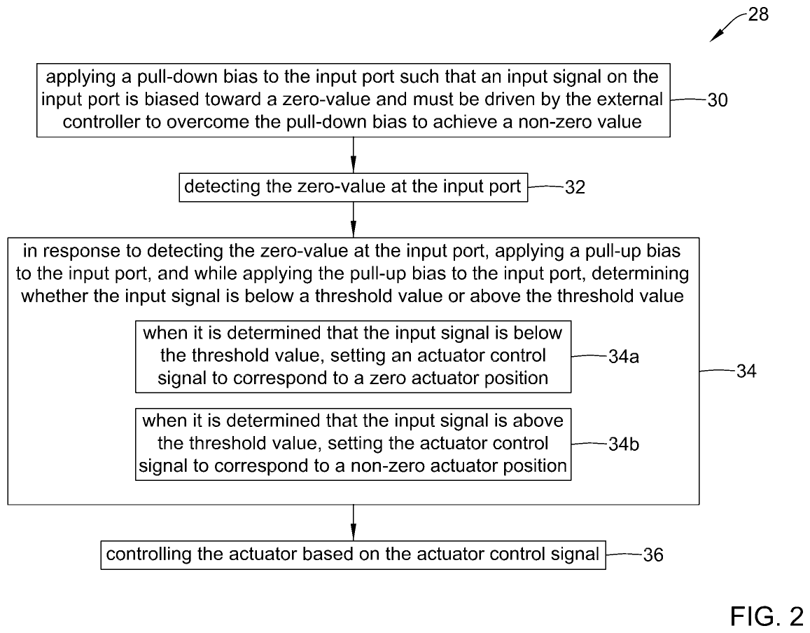

FIG. 2 is a flow diagram showing an illustrative method 28 for controlling an actuator, wherein the actuator receives an input signal at an input port (such as the input port 16) from an external controller (such as the external controller 12). The illustrative method 28 includes applying a pull-down bias to the input port such that an input signal on the input port is biased toward a zero-value and must be driven by the external controller to overcome the pull-down bias to achieve a non-zero value, as indicated at block 30. The zero-value at the input port is detected, as indicated at block 32. The method 28 includes, in response to detecting the zero-value at the input port, applying a pull-up bias to the input port, and while applying the pull-up bias to the input port, determining whether the input signal is below a threshold value or above the threshold value, as indicated at block 34. In some instances, applying the pull-up bias to the input port may include closing a pull-up switch to electrically interconnect a pull-up resistance between the input port and a pull-up voltage. In some instances, applying the pull-up bias to the input port may include opening a pull-down switch to electrically disconnect a pull-down resistance from the input port and ground.

When it is determined that the input signal is below the threshold value, an actuator control signal is set to correspond to a zero actuator position, as indicated at block 34a. When it is determined that the input signal is above the threshold value, the actuator control signal is set to correspond to a non-zero actuator position, as indicated at block 34b. In some instances, the non-zero actuator position may correspond to a non-zero target position of the actuator, an existing position of the actuator, or any other position. The actuator is controlled based on the actuator control signal, as indicated at block 36.

In some instances, the zero-value may correspond to a voltage that is below a zero-value threshold, and the non-zero value may correspond to a voltage above the zero-value threshold. The zero-value threshold may be, for example, 1 volt, 0.5 volts, 0.2 volts, 0.1 volts or any other threshold. In some cases, the threshold value may correspond to the zero-value threshold.

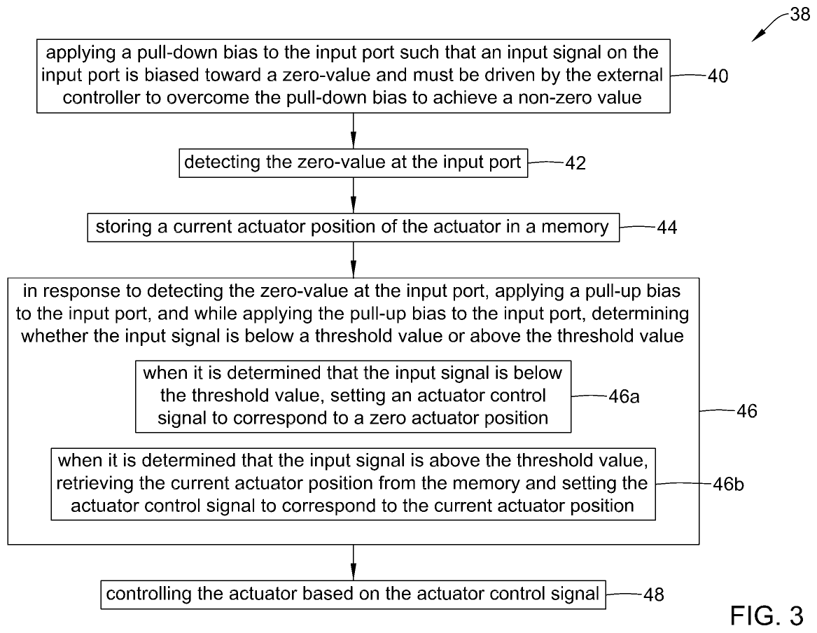

FIG. 3 is a flow diagram showing an illustrative method 38 for controlling an actuator, wherein the actuator receives an input signal at an input port (such as the input port 16) from an external controller (such as the external controller 12). The method 38 includes applying a pull-down bias to the input port such that an input signal on the input port is biased toward a zero-value and must be driven by the external controller to overcome the pull-down bias to achieve a non-zero value, as indicated at block 40. The zero-value at the input port is detected, as indicated at block 42. A current actuator position is stored in a memory, as indicated at block 44.

The illustrative method 38 includes, in response to detecting the zero-value at the input port, applying a pull-up bias to the input port, and while applying the pull-up bias to the input port, determining whether the input signal is below a threshold value or above the threshold value, as indicated at block 46. When it is determined that the input signal is below the threshold value, an actuator control signal is set to correspond to a zero actuator position, as indicated at block 46a. When it is determined that the input signal is above the threshold value, the current actuator position is retrieved from the memory and the actuator control signal is set to correspond to the current actuator position, as indicated at block 46b. The actuator is controlled based on the actuator control signal, as indicated at block 48.

In some instances, the zero-value may correspond to a voltage that is below a zero-value threshold, and the non-zero value may correspond to a voltage above the zero-value threshold. In some cases, the threshold value may correspond to the zero-value threshold. In some instances, applying the pull-up bias to the input port may include closing a pull-up switch to electrically interconnect a pull-up resistance between the input port and a pull-up voltage. In some instances, applying the pull-up bias to the input port may include opening a pull-down switch to electrically disconnect a pull-down resistance from the input port and ground.

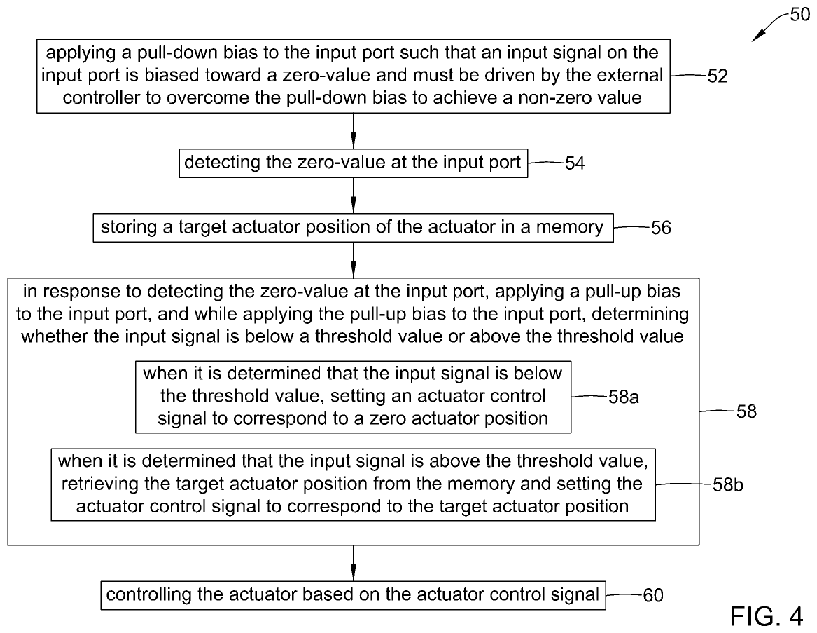

FIG. 4 is a flow diagram showing an illustrative method 50 for controlling an actuator, wherein the actuator receives an input signal at an input port (such as the input port 16) from an external controller (such as the external controller 12). The method 50 includes applying a pull-down bias to the input port such that an input signal on the input port is biased toward a zero-value and must be driven by the external controller to overcome the pull-down bias to achieve a non-zero value, as indicated at block 52. The zero-value at the input port is detected, as indicated at block 54. A target actuator position is stored in a memory, as indicated at block 56.

The illustrative method 50 includes, in response to detecting the zero-value at the input port, applying a pull-up bias to the input port, and while applying the pull-up bias to the input port, determining whether the input signal is below a threshold value or above the threshold value, as indicated at block 58. When it is determined that the input signal is below the threshold value, an actuator control signal is set to correspond to a zero actuator position, as indicated at block 58a. When it is determined that the input signal is above the threshold value, the target actuator position is retrieved from the memory and the actuator control signal is set to correspond to the target actuator position, as indicated at block 46b. The actuator is controlled based on the actuator control signal, as indicated at 60 48.

In some instances, the zero-value may correspond to a voltage that is below a zero-value threshold, and the non-zero value may correspond to a voltage above the zero-value threshold. In some cases, the threshold value may correspond to the zero-value threshold. In some instances, applying the pull-up bias to the input port may include closing a pull-up switch to electrically interconnect a pull-up resistance between the input port and a pull-up voltage. In some instances, applying the pull-up bias to the input port may include opening a pull-down switch to electrically disconnect a pull-down resistance from the input port and ground.

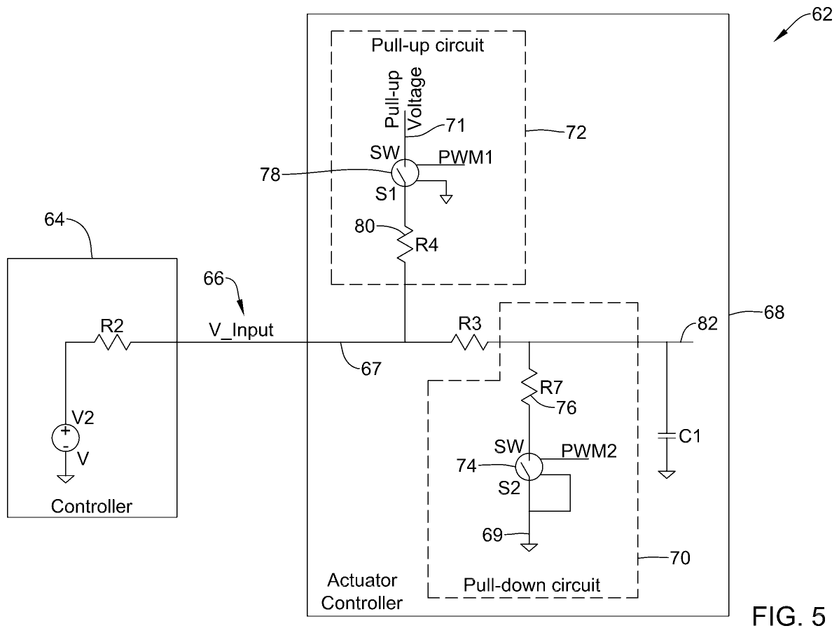

FIG. 5 is a schematic diagram showing an illustrative embodiment 62 that includes an actuator controller 68 and an external controller 64. The actuator controller 68 may include a circuit that may be an example of circuit 20, and the external controller 64 may be an example of external controller 12 of FIG. 1. Although not explicitly shown, the actuator controller 68 may include an MCU or equivalent, which may receive the MCU_ADC value 82, and provide appropriate control signals to the switches 74 and 78. The external controller 64 provides a Y input control signal 66 to actuator controller 68. The illustrative actuator controller 68 includes a pull-down circuit 70, which may be considered as being an example of the pull-down circuit 22, and a pull-up circuit 72, which may be considered as being an example of the pull-up circuit 24.

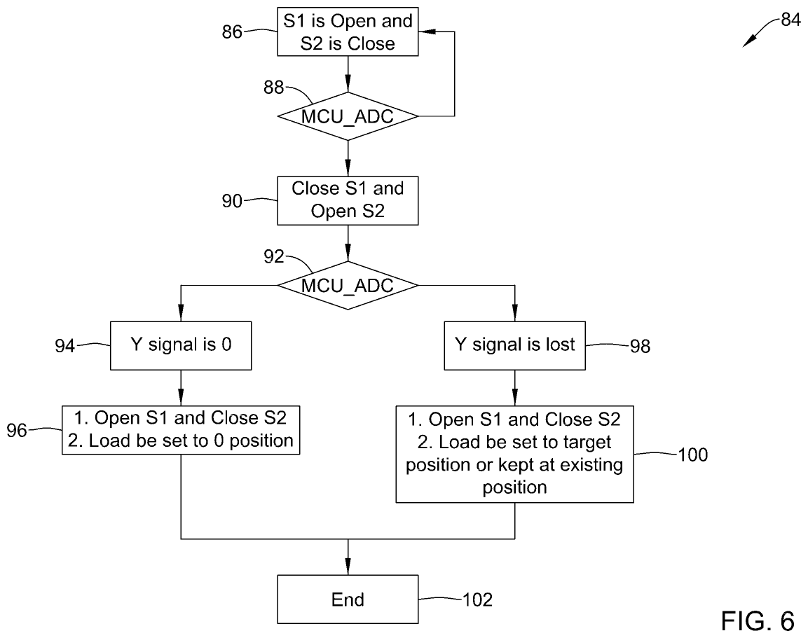

The illustrative pull-down circuit 70 includes a switch 74 that may be opened or closed, and a resistor 76 (labeled as R7) that provides a pull-down resistance that is positioned electrically between the input port 67 and ground 69. The switch 74 may be considered as being a pull-down switch, for example. The pull-up circuit 72 includes a switch 78 that may be opened or closed, and a resistor 80 (labeled as R4) that provides a pull-up resistance that is electrically between the input port 67 and a pull-up voltage 71. The switch 78 may be considered as being a pull-up switch, for example. The circuit shown outputs an MCU_ADC value 82. The MCU_ADC value 82 may serve as an input to an MCU (not shown), which may implement the illustrative method 84 shown in FIG. 6.

FIG. 6 is a flow diagram showing the illustrative method 84. In some cases, the method 84 may be carried out by an MCU, such as the MCU 26 (FIG. 1). Control begins at block 86, where switch 1 (switch 78 of FIG. 5) is open and switch 2 (switch 74 of FIG. 5) is closed. At decision block 88, the MCU_ADC value 82 is compared with a threshold. When the MCU_ADC value 82 is greater than the threshold, meaning that the Y signal 66 is being actively driven by the external controller 64 to a non-zero value, control reverts back to block 86.

If, however, the MCU_ADC value 82 is less than or equal to the threshold, switch 1 (switch 78) is closed and switch 2 (switch 74) is opened, as indicated at block 90. At decision block 92, the MCU_ADC value 82 is compared with the pull up voltage. If the MCU_ADC value 82 is less than the pull up voltage, this is an indication that the Y signal 66 is being actively driven to zero by the external controller 64. This is indicated at block 94. Switch 1 (switch 78) is opened and switch 2 (switch 74) is closed, and the actuator load is set equal to the zero position, as indicated at block 96. Control then passes to block 102, where the method 84 terminates.

If the MCU_ADC value 82 equals the pullup voltage, this is an indication that the Y signal 66 is not actively driven by the external controller 64 and has been lost, as indicated at block 98. Switch 1 (switch 78) is opened and switch 2 (switch 74) is closed, and the actuator load is set equal to either a target position or kept at a current or existing position, as indicated at block 100. Control then passes to block 102, where the method 84 terminates.

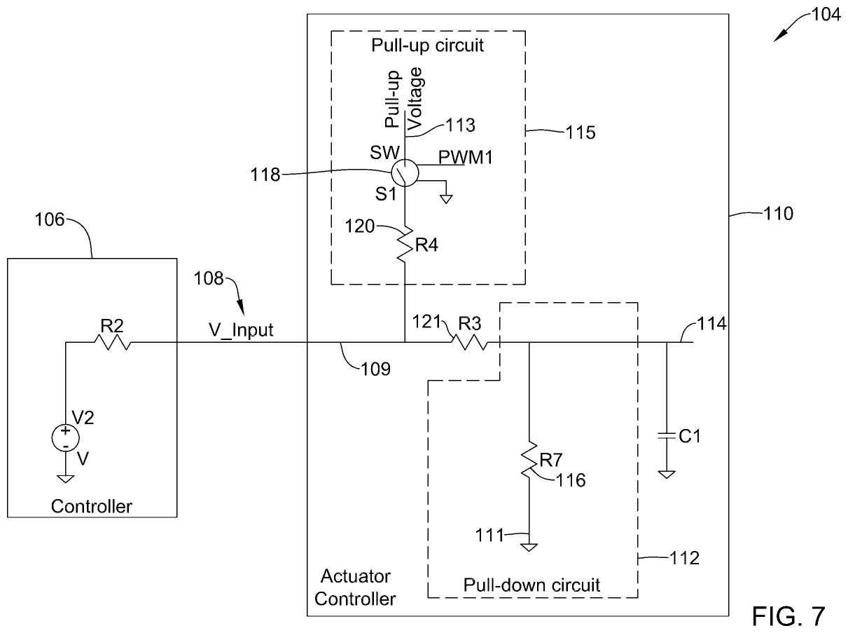

FIG. 7 is a schematic diagram showing an illustrative embodiment 104 that includes an actuator controller 110 and an external controller 106. The actuator controller 110 may include a circuit that may be an example of circuit 20, and the external controller 106 may be an example of external controller 12 of FIG. 1. Although not explicitly shown, the actuator controller 110 may include an MCU or equivalent, which may receive the MCU_ADC value 114, and provide appropriate control signals to switch 118. The controller 106, which may be considered as an example of the external controller 12 of FIG. 1, provides a Y input control signal 108 to actuator controller 110. The illustrative actuator controller 110 includes a pull-down circuit 112, which may be considered as being an example of the pull-down circuit 22 of FIG. 1, and a pull-up circuit 115, which may be considered as being an example of the pull-up circuit 24 of FIG. 1.

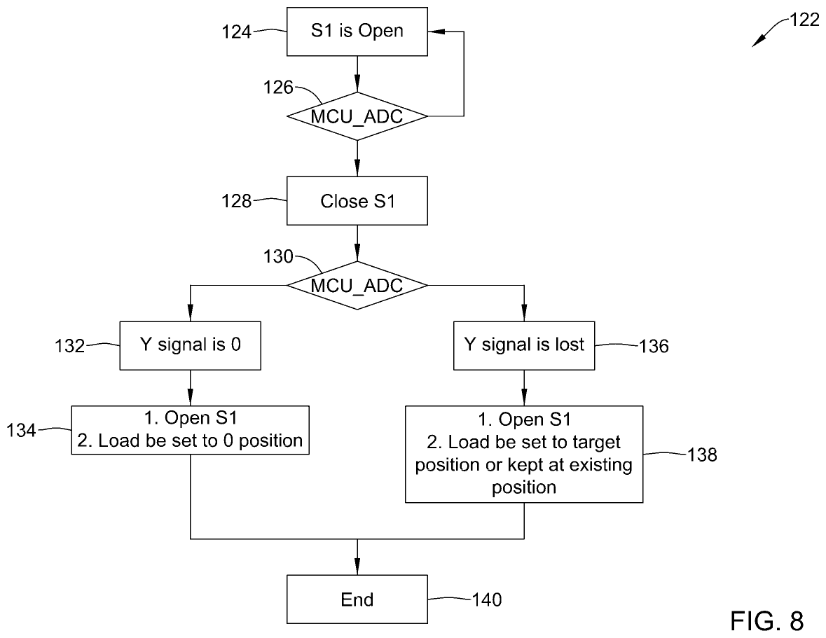

In this embodiment, the pull-down circuit 112 does not include a switch, but does include a resistor 116 (labeled as R7) that provides a pull-down resistance that is positioned electrically between the input port 109 and ground 111. The pull-up circuit 115 includes a switch 118 that may be opened or closed, and a resistor 120 (labeled as R4) that provides a pull-up resistance that is positioned electrically between the input port 109 and a pull-up voltage 113. The switch 118 may be considered as being a pull-up switch, for example. The circuit shown outputs an MCU_ADC value 114. The MCU_ADC value 114 may serve as an input to an MCU (not shown), which may implement the illustrative method 122 shown in FIG. 8.

FIG. 8 is a flow diagram showing the illustrative method 122. In some cases, the method 122 may be carried out by an MCU, such as the MCU 26 (FIG. 1). Control begins at block 124, where switch 1 (switch 78) is open. At decision block 126, the MCU_ADC value 114 is compared with a threshold. When the MCU_ADC value 114 is greater than the threshold, meaning that the Y signal 108 is being actively by the external controller 106 to a non-zero value, control reverts back to block 124.

If, however, the MCU_ADC value 114 is less than or equal to the threshold, switch 1 (switch 78) is closed, as indicated at block 128. With the switch 1 closed, and at decision block 130, the MCU_ADC value 114 is compared with a threshold voltage. The threshold may be based on the pull up voltage as divided by resistors R4 120, R3 121 and R7 116). If the MCU ADC value 114 is less than the threshold, this is an indication that the Y signal 108 is being actively driven by the external controller 106 to zero, as indicated at block 132. Switch 1 (switch 78) is opened, and the actuator load is set equal to the zero position, as indicated at block 134. Control then passes to block 140, where the method 122 terminates.

If the MCU ADC value 114 equals the threshold, this is an indication that the Y signal 108 is not actively driven by the external controller 106 and has been lost, as indicated at block 136. Switch 1 (switch 78) is opened, and the actuator load is set equal to either a target position or kept at a current or existing position, as indicated at block 138. Control then passes to block 140, where the method 122 terminates.

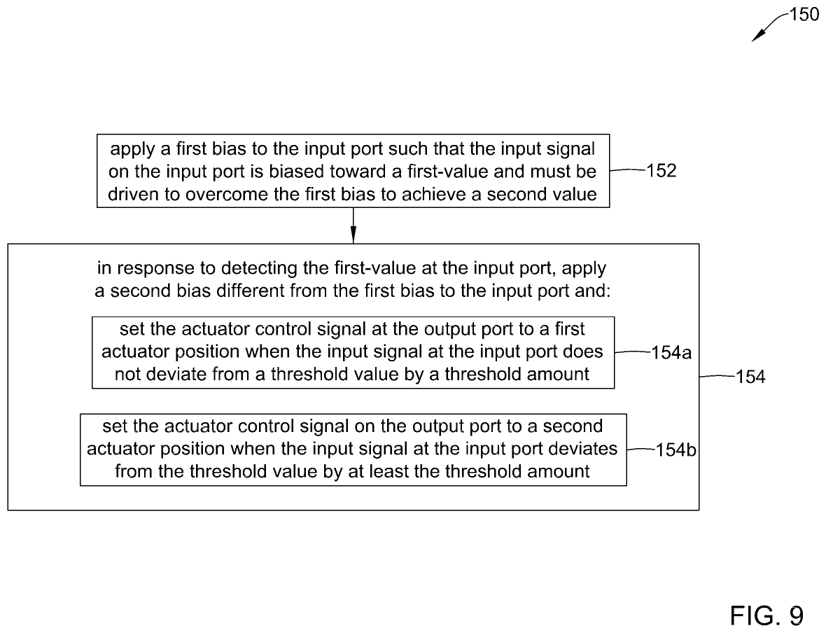

FIG. 9 is a flow diagram showing an illustrative series of steps 150 that may be carried out via the circuit 20, the circuit 64 and/or the circuit 104. The circuit 20, the circuit 64 and/or the circuit 104 may be configured to apply a first bias to the input port such that the input signal on the input port is biased toward a first-value and must be driven to overcome the first bias to achieve a second value, as indicated at block 152. In response to detecting the first-value at the input port, the circuit 20, the circuit 64 and/or the circuit 104 may be configured to apply a second bias different from the first bias to the input port, as indicated at block 154. The circuit 20, the circuit 64 and/or the circuit 104 may be configured to set the actuator control signal at the output port to a first actuator position when the input signal at the input port does not deviate from a threshold value by a threshold amount, as indicated at block 154a. The circuit 20, the circuit 64 and/or the circuit 104 may be configured to set the actuator control signal on the output port to a second actuator position when the input signal at the input port deviates from the threshold value by at least the threshold amount, as indicated at block 154b. In some instances, the first bias may be a pull-down bias and the second bias may be a pull-up bias. In some instances, the first bias may be a pull-up bias and the second bias may be a pull-down bias.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. An actuator controller for controlling an actuator, comprising:
an input port for receiving an input signal from an external controller;
an output port for providing an actuator control signal to an actuator position controller of the actuator;
a circuit operatively coupled to the input port and the output port, the circuit configured to:
apply a pull-down bias to the input port such that the input signal on the input port is biased toward a zero-value and must be driven to overcome the pull-down bias to achieve a non-zero value;
in response to detecting the zero-value at the input port, apply a pull-up bias to the input port and:
set the actuator control signal at the output port to correspond to a zero actuator position when the input signal at the input port is below a threshold value; and
set the actuator control signal on the output port to correspond to a non-zero actuator position when the input signal at the input port rises above the threshold value.

2. The actuator controller of claim 1, wherein the non-zero actuator position corresponds to a non-zero target position of the actuator or an existing position of the actuator.

3. The actuator controller of claim 1, wherein the zero-value corresponds to a voltage that is below a zero-value threshold, and the non-zero value corresponds to a voltage above the zero-value threshold.

4. The actuator controller of claim 1, wherein the circuit comprises a pull-down circuit that applies the pull-down bias to the input port, wherein the pull-down circuit includes a pull-down resistance positioned electrically between the input port and ground.

5. The actuator controller of claim 4, wherein the pull-down circuit comprises a pull-down switch that selectively electrically interconnects the pull-down resistance between the input port and ground.

6. The actuator controller of claim 1, wherein the circuit comprises a pull-up circuit that applies the pull-up bias to the input port, wherein the pull-up circuit includes a pull-up resistance positioned electrically between the input port and a pull-up voltage.

7. The actuator controller of claim 6, wherein the pull-up circuit comprises a pull-up switch that selectively electrically interconnects the pull-up resistance between the input port and the pull-up voltage.

8. The actuator controller of claim 7, wherein the circuit comprises a micro control unit (MCU) that controls the pull-up switch.

9. The actuator controller of claim 8, wherein the MCU is configured to:
detect the zero-value at the input port;
in response to detecting the zero-value at the input port:
close the pull-up switch to selectively electrically interconnect the pull-up resistance between the input port and the pull-up voltage;
after closing the pull-up switch, determine whether the input signal at the input port is below the threshold value or above the threshold value;
when it is determined that the input signal is below the threshold value, set the actuator control signal at the output port to correspond to the zero actuator position; and
when it is determined that the input signal is above the threshold value, set the actuator control signal at the output port to correspond to the non-zero actuator position.

10. The actuator controller of claim 9, wherein the circuit comprises:
a pull-down circuit that applies the pull-down bias to the input port, wherein the pull-down circuit includes:
a pull-down resistance electrically between the input port and ground;
a pull-down switch that selectively electrically interconnects the pull-down resistance between the input port and ground;
wherein the MCU is configured to:
open the pull-up switch and close the pull-down switch when applying the pull-down bias; and
open the pull-down switch and close the pull-up switch in response to detecting the zero-value at the input port.

11. A method for controlling an actuator, wherein the actuator receives an input signal at an input port from an external controller, the method comprising:
applying a pull-down bias to the input port such that an input signal on the input port is biased toward a zero-value and must be driven by the external controller to overcome the pull-down bias to achieve a non-zero value;
detecting the zero-value at the input port;
in response to detecting the zero-value at the input port, applying a pull-up bias to the input port, and while applying the pull-up bias to the input port, determining whether the input signal is below a threshold value or above the threshold value;
when it is determined that the input signal is below the threshold value, setting an actuator control signal to correspond to a zero actuator position;
when it is determined that the input signal is above the threshold value, setting the actuator control signal to correspond to a non-zero actuator position; and
controlling the actuator based on the actuator control signal.

12. The method of claim 11, wherein the non-zero actuator position corresponds to a non-zero target position of the actuator or an existing position of the actuator.

13. The method of claim 11, further comprising:
storing a current actuator position of the actuator in a memory; and
setting the actuator control signal to the non-zero actuator position includes retrieving the current actuator position from the memory and setting the actuator control signal to correspond to the current actuator position.

14. The method of claim 11, further comprising:
storing a target actuator position of the actuator in a memory; and
setting the actuator control signal to the non-zero actuator position includes retrieving the target actuator position from the memory and setting the actuator control signal to correspond to the target actuator position.

15. The method of claim 11, wherein the zero-value corresponds to a voltage that is below a zero-value threshold, and the non-zero value corresponds to a voltage above the zero-value threshold.

16. The method of claim 11, wherein applying the pull-up bias to the input port includes closing a pull-up switch to electrically interconnect a pull-up resistance between the input port and a pull-up voltage.

17. The method of claim 15, wherein applying the pull-up bias to the input port includes opening a pull-down switch to electrically disconnect a pull-down resistance from the input port and ground.

18. An actuator controller for controlling an actuator, comprising:
an input port for receiving an input signal from an external controller;
an output port for providing an actuator control signal to an actuator position controller of the actuator;
a circuit operatively coupled to the input port and the output port, the circuit configured to:
apply a first bias to the input port such that the input signal on the input port is biased toward a first-value and must be driven to overcome the first bias to achieve a second value;
in response to detecting the first-value at the input port, apply a second bias different from the first bias to the input port and:
set the actuator control signal at the output port to a first actuator position when the input signal at the input port does not deviate from a threshold value by a threshold amount; and
set the actuator control signal on the output port to a second actuator position when the input signal at the input port deviates from the threshold value by at least the threshold amount.

19. The actuator controller of claim 18, wherein the first bias is a pull-down bias and the second bias is a pull-up bias.

20. The actuator controller of claim 18, wherein the first bias is a pull-up bias and the second bias is a pull-down bias.
